(19) United States
(12) Patent Application Publication
(10) Pub. No.: US 2010/0049857 A1
(43) Pub. Date: Feb. 25, 2010

(54) SYSTEM SOFTWARE PRODUCTIZATION FRAMEWORK

(76) Inventor: Scott Allan Libert, Tigard, OR (US)

Correspondence Address: Robert D. Shedd, Patent Operations;THOMSON Licensing LLC, P.O. Box 5312, Princeton, NJ, 08543-5312, US

(21) Appl. No.: 12/450,799

(22) PCT Filed: Dec. 17, 2007
(86) PCT No.: PCT/US2007/025756

§ 371 Date: Oct. 13, 2009

Related U.S. Application Data
(60) Provisional application No. 60/923,408, filed on Apr. 13, 2007.

(51) Int. Cl. G06F 15/16

(52) U.S. Cl. 709/228

(57) ABSTRACT

A unified framework is established based on a domain-specific system description model representative of physical network system topology, network system device capability and/or logical network system structure. The framework can be employed to streamline a network system configuration process and/or a software system deployment process and the like. Some instances can also be utilized in establishing a unified framework in a broadcast equipment environment to augment network system based technologies. Additionally, network devices having multiple network interfaces that are dedicated to specific network usages can be automatically configured. A method in accordance with an aspect of the present principles includes generating a site model with a plurality of groups of device model network interfaces that can represent dedicate networks. The device model interfaces are grouped according to usage and network medium type and are logically associated with pre-defined IP addresses. The site model is applied to the network devices to logically associate them into dedicated networks by automatically assigning the pre-defined IP addresses to the network interfaces of the devices.

### RELATED APPLICATIONS

The present application claims priority from U.S. Provisional Application Ser. No. 60/923,408 entitled, SYSTEM SOFTWARE PRODUCTIZATION FRAMEWORK, filed on Apr. 13, 2007.

### TECHNICAL FIELD

The present principles generally relate to systems and methods for configuring network devices in conjunction with deploying and/or configuring software.

### BACKGROUND OF THE INVENTION

Configuration of a network of computing devices dedicated for particular uses fundamentally involves assignment of addresses to the devices and associating devices that serve a common function into a subnet. Dynamic Host Configuration Protocol (DHCP) Servers and Domain Name System (DNS) servers are popular mechanisms employed for automatic assignment of Internet Protocol (IP) addresses to computing devices on a network. Regarding DHCP servers, for example, IP addresses can be assigned manually, automatically, or dynamically. Additionally, for example, if a network is dedicated to a file transfer function, devices that enable file transfer throughout the network must be associated to form the dedicated sub-network. In addition, certain devices commonly compose more than one network. A device can, for example, simultaneously be associated with a file transfer network, a storage network, and others. Currently, associating devices that compose multiple dedicated networks is performed manually by an administrator.

### SUMMARY OF THE INVENTION

A unified framework is established based on a domain-specific system description model representative of physical network system topology, network system device capability and/or logical network system structure. The framework can be employed to streamline a network system configuration process and/or a software system deployment process and the like. The unified framework can be established in a broadcast equipment environment to augment network system based technologies. Other instances can provide methods and/or systems for automatically and efficiently associating devices with multiple interfaces having dedicated usages and redundant connections by employing site models. This aspect avoids tedious and time consuming manual network configuration methods by permitting a user to select a site model with pre-defined address allocations to automatically configure dedicated networks of such devices.

One implementation includes a method for configuring networked devices having network interfaces that are dedicated to specific network usages including - generating at least one site model including at least two groups of device model interfaces, wherein device model interfaces are grouped and logically associated in accordance with dedicated usage by assigning addresses to the device model interfaces; storing the at least one site model in a configuration database; and logically associating, upon selection of the at least one site model, a first plurality of network devices, each device having a plurality of network interfaces that have dedicated usages, by assigning addresses to the network interfaces in accordance with the at least one site model to automatically form at least two dedicated networks corresponding to dedicated usage of said at least two groups. Another aspect of the present principles includes a configuration database providing at least one site model including at least two groups of device model interfaces, wherein device model interfaces are grouped and logically associated in accordance with dedicated usage by assigning addresses to the device model interfaces, and wherein the address assignment forms models of at least two dedicated networks corresponding to dedicated usage of said at least two groups.

A system implementation of an aspect of the present principles includes a configuration database including: at least one site model including at least two groups of device model interfaces, wherein device model interfaces are grouped and logically associated in accordance with dedicated usage by assigning addresses to the device model interfaces; and a control unit configured to logically associate, upon selection of the at least one site model, a first plurality of network devices, each device having a plurality of network interfaces that have dedicated usages, by assigning addresses to the network interfaces in accordance with the at least one site model to automatically form at least two dedicated networks corresponding to dedicated usage of said at least two groups.

The details of one or more implementations are set forth in the accompanying drawings and the description below. Even if described in one particular manner, it should be clear that implementations can be configured or embodied in various manners. For example, an implementation can be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

The teachings of the present invention can be readily understood by considering the following detailed description in conjunction with the accompanying drawings, in which:

FIG. 1 is a block diagram depicting a system for deploying and configuring software for a network of devices that have Multiple network interfaces with various Dedicated Usages (MDU devices) in accordance with an aspect of the present principles.

FIG. 2 is a block diagram illustrating an implementation of a configuration repository utilized in deploying and configuring software on networked MDU devices.

FIG. 3 is a flow diagram of an overview of a method for deploying software and configuring networks of MDU devices in accordance with an aspect of the present principles.

FIG. 4 is a flow diagram depicting an exemplary implementation of a method for configuring a plurality of dedicated networks of MDU devices having various usages.

FIG. 5 is flow diagram illustrating an example of a method for deploying software on a network of MDU devices in accordance with an aspect of the present principles.

FIG. 6 is a flow diagram of an implementation of a method for configuring software on MDU devices composing dedicated networks.

FIG. 7 is a flow diagram depicting a method for dispatching configuration snapshots.

FIG. 8 is a block diagram of an illustrative example of a media server to which aspects of the present principles can be applied.

FIG. 9 is a block diagram of an illustrative example of a media client to which aspects of the present principles can be applied.

FIG. 10 is a block diagram depicting an example of a configuration database including site models.

FIG. 11 is a block diagram of an exemplary device model including six network interfaces that each correspond to a dedicated usage and network medium type.

FIG. 12 is a block diagram of an exemplary device model including three network interfaces that each correspond to a dedicated usage and network medium type.

FIGS. 13-15 are block diagrams of illustrative examples of network models having particular dedicated usages and network medium types with corresponding IP address ranges.

FIG. 16 is a block diagram of an illustrative example of a site model including groups that can represent dedicated networks having network interfaces with addresses assigned in accordance with corresponding network models.

It should be understood that the drawings are for purposes of illustrating the concepts of the present principles and are not necessarily the only possible configuration for illustrating the present principles. To facilitate understanding, identical reference numerals have been used, where possible, to designate identical elements that are common to the figures.

### DETAILED DESCRIPTION OF THE INVENTION

The present principles provide systems and methods for configuring a network, for example, of devices having redundant connections and multiple interfaces with various dedicated usages. In one implementation of the present principles, the configuration of network devices is employed in a system software deployment framework. However, it should be understood that that the present principles can be applied to any configuration process entailing configuration of network devices having multiple, dedicated network interfaces.

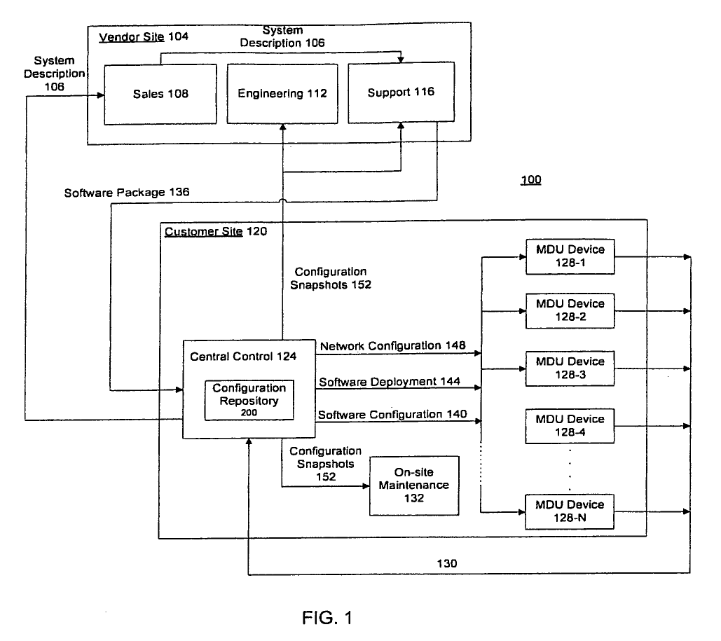

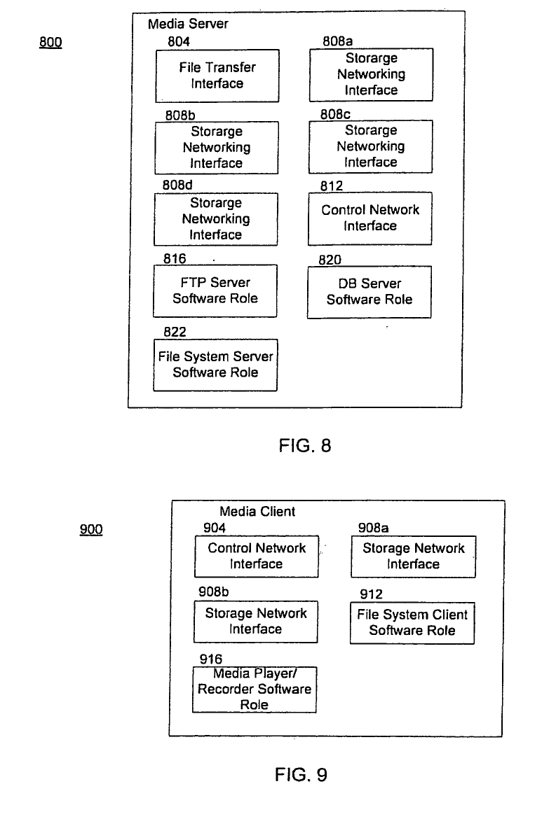

Referring now in specific detail to the drawings in which like reference numerals identify similar or identical elements throughout the several views, and initially to FIG. 1, an exemplary implementation of the present principles includes a system 100 for configuring network devices. Specifically, in this illustrative implementation of the present principles, devices that have Multiple network interfaces with various Dedicated Usages (MDU devices) 128 are configured into dedicated networks by automatically assigning pre-defined IP addresses in accordance with site models. Illustrative examples of MDU devices include media servers and media clients, as depicted in FIGS. 8 and 9. Although aspects of the present principles are described herein with respect to media servers and clients, it should be understood that the present principles can be applied to any type of MDU devices such as archive servers, dedicated edit workstations, browse encoders and other devices.

As discussed above, an MDU device can include several interfaces that each can compose different dedicated networks. In accordance with an aspect of the present principles, multiple dedicated networks of such devices can be configured by utilizing site models, as described more fully below. Prior to describing configuration methods according to aspects of the present principles, a detailed description of examples of MDU is provided herein. FIGS. 8 and 9 are block diagrams illustrative of media servers and clients, respectively, which are examples of MDU devices. Functions of a media server 800 can include management of file storage systems and file transfer operations. In addition, a media client 900 can permit playing, recording, or editing media files. The media server 800 can include several network interfaces, each of which can have a distinct dedicated usage. For example, the illustrative media server 800 includes six dedicated network interfaces: one interface dedicated to file transfers 804; four interfaces dedicated to storage networking 808a-d; and one interface dedicated to a control network 812. Similarly, the media client can also include multiple network interfaces having distinct dedicated usages. As depicted in the illustrative example of FIG. 9, a media client 900 includes one network interface dedicated to the control network 904 and two redundant network interfaces 908a-b devoted to storage networking. The storage networking interfaces are redundant in that each interface is connected to two different media servers to ensure that the client has access to the storage network should one media server be inoperable. Thus, redundant connections provide multiple access points to a network.

It should also be noted that other features of media servers and clients include a description of software roles. As indicated in FIG. 8, a media server 800 can include descriptions of software roles such as an FTP Server role 816, a DB Server role, and the File System Server role 822. Software roles of a media client 900 can include a File System Client role 912 and a Media Player/Recorder Software role 916. Software roles can be employed to characterize MDU devices when constructing device models that are used in configuring dedicated networks of MDU devices, described more fully below.

The network interfaces of the media servers, media clients and other network devices such as routers, switches, busses and hubs, can be logically associated to form dedicated networks. For example, logical associations of such devices can be made to form networks devoted to file transfer, storage networking and control, as more fully described below with regard to an implementation of a configuration method 400. The control network can be used to form dedicated networks by assigning IP addresses to devices that compose them, also described more fully below. In addition, dedicated networks comprised of MDU devices can be “closed” in that no routes connect them to other dedicated networks. Moreover, the topology can be highly complex and, thus, it should be noted that FIG. 1 does not illustrate logical associations of MDU devices after formation of a dedicated network.

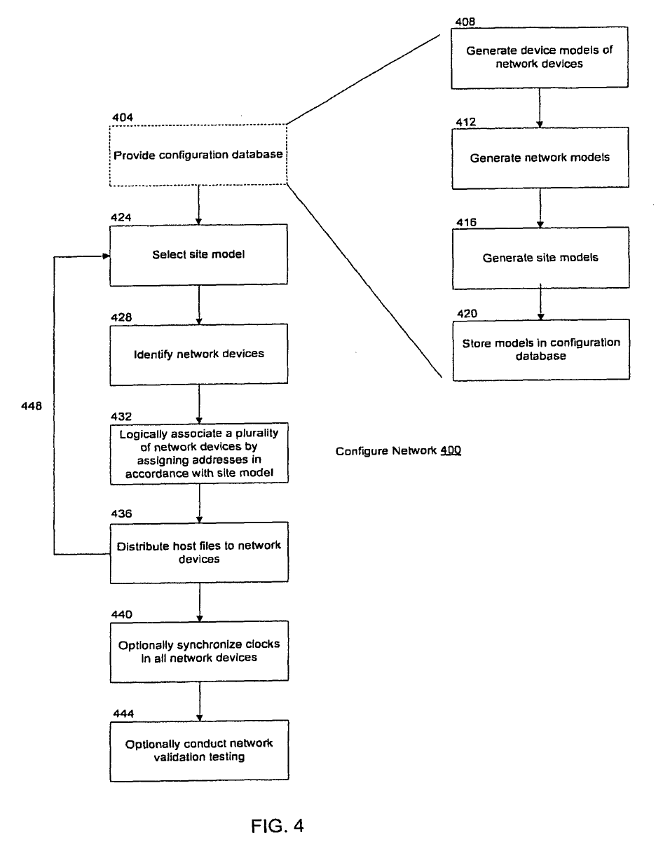

Referring to FIG. 4 with continuing reference to FIG. 1, in accordance with an aspect of the present principles, method 400 can be utilized to configure dedicated networks of MDU devices. The network configuration steps 400 can be implemented by employing network configuration commands 148 over a control network (not shown in FIG. 1). The network configuration commands can be provided by a central control unit 124. In one implementation, the central control unit 124 is a user-computer including memory, a processor and appropriate software that hosts a single application implementing the configuration methods described more fully below. It should be noted that the network configuration steps 400 described herein can be performed over a single control network, through which other, dedicated networks can be configured. For example, the central control unit 124 configures MDU devices and deploys software to them by issuing commands over the control network. As described below, the control unit 124 can assign pre-defined IP addresses to network interfaces of MDU devices to thereby form and configure other dedicated networks, which can be closed, as stated above.

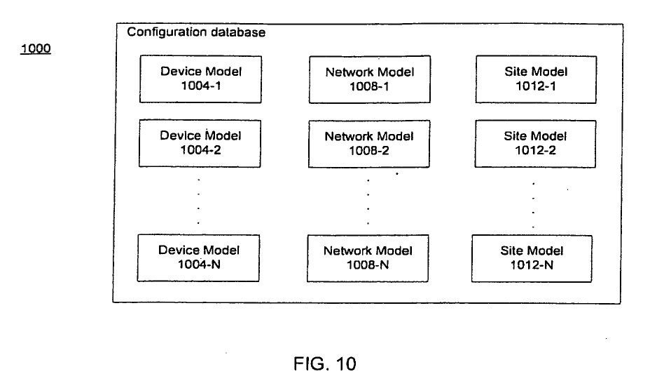

With reference to FIGS. 4, 8 and 10, the network configuration method 400 in accordance with an aspect of the present principles begins by providing a configuration database in step 404. FIG. 10 is a depiction of an illustrative example of a configuration database 1000. A configuration database can provide multiple network configuration models that include pre-defined logical topology associations of MDU devices. As described above, MDU devices can compose dedicated networks devoted to specific functions, such as file transfer and storage networking. Moreover, a single MDU device can compose more than one dedicated network through different network interfaces on the device. For example, with reference to FIG. 8, one MDU network interface 804 can connect to a file transfer network and a different MDU network interface 808a can connect to a storage network.

Referring to FIG. 10, one aspect of the present principles includes providing models of network configurations of MDU devices composing multiple dedicated networks. The pre-defined configurations facilitate building a dedicated network or adding a new MDU device to already existing dedicated networks. The pre-defined configurations can be stored in a configuration database 1000. As illustrated in FIG. 10, in one exemplary implementation of the present principles, a configuration database 1000 utilized in configuring dedicated networks can include: device models 1004 for various MDU devices, network models 1008, and site models 1012. Device models and network models ease the construction of a site model and can be reused to construct different site models.

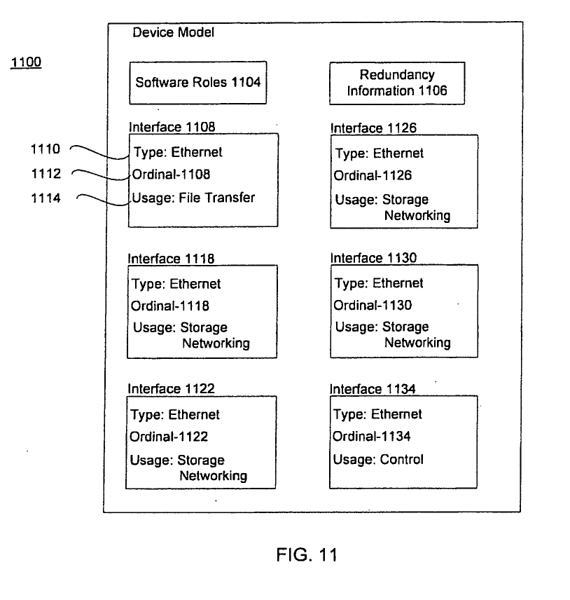

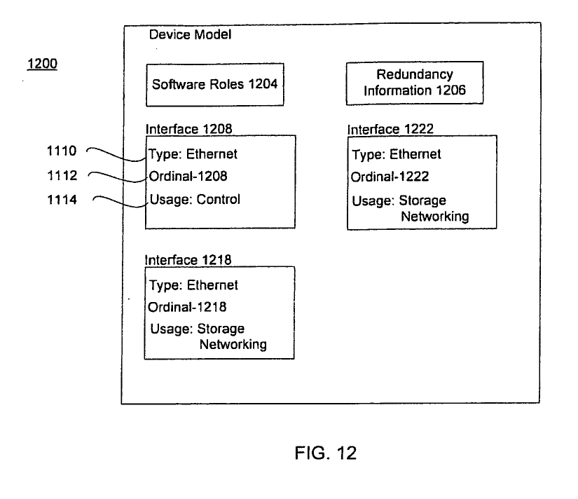

FIGS. 11 and 12 correspond to examples of device models. The particular device models presented in FIGS. 11 and 12 represent a media server 800 and a media client 900, respectively. For each network interface of a particular MDU device, a device model can comprise descriptions of: a network medium type 1110, such as Ethernet or Fiber Channel; an ordinal 1112, indicating the physical location of the network interface on the device; and a dedicated network usage 1114, such as, for example, file transfer, storage networking, control network and general usage. In the device model of FIG. 11, interface 1108 is described as including an Ethernet network medium type and a file transfer usage. Moreover, other network interfaces can correspond to other network usages, as illustrated in FIGS. 11 and 12, and types. In addition, device models can also include a description of software roles 1104, 1204, and redundancy information 1106, 1206. Software role descriptions indicate the software component subsystems with which the MDU device is compatible. Furthermore, redundancy information comprises a description of the type of redundant connection each interface provides, such as “none,” “primary,” “secondary,” etc.

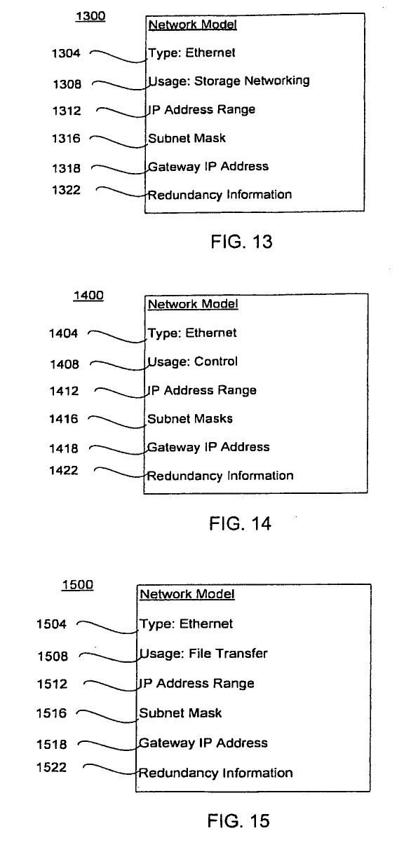

As illustrated in FIG. 13, network models can comprise descriptions of type 1304; usage 1308; redundancy information 1322; IP address ranges 1312; subnet masks 1316; and gateway IP addresses 1318. The examples provided in FIGS. 13-15, respectively, are block diagrams of different network models: a network model 1300 having a storage networking usage with an Ethernet network medium; a network model 1400 having control usage with an Ethernet network medium; and a network model 1500 having a file transfer usage with an Ethernet network medium. Each network model includes their own corresponding IP address range, subnet masks, gateway IP addresses and redundancy information. The pre-defined addresses and subnet masks are later assigned to MDU device interfaces that compose a common dedicated network and are specifically designed to logically associate the MDU devices. As referred to herein, device interfaces are logically associated in that they are assigned IP addresses within a network's IP address range. In accordance with another aspect of the present principles, MDU devices are automatically assigned addresses by applying a site model.

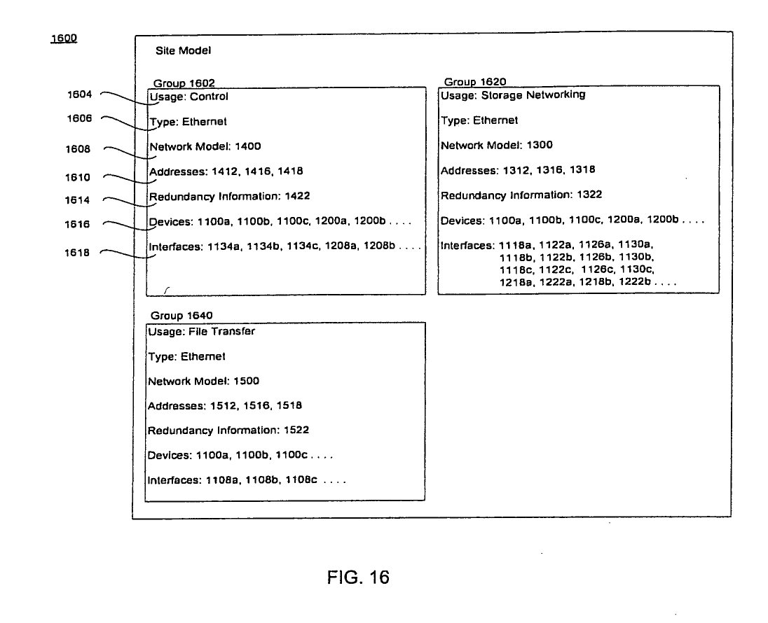

A site model, as depicted in FIG. 16, can include a plurality of descriptions of network models 1608 and device models 1616 that are included in a site. Each site model can include different numbers and types of MDU device models and network models. In the block diagram of a site model provided in FIG. 16, the site model includes three network models 1400, 1300, and 1500, each of which are illustrated in FIGS. 14, 13 and 15 respectively. In addition, the site model of FIG. 16 also includes descriptions from five device models: three media servers, 1100a, 1100b, and 1100c and two media clients, 1200a, 1200b. Within a site model, MDU device interfaces can be grouped according to dedicated usage and/or type. For example, in group 1620, interfaces of devices 1100a, 1100b, 1100c, 1200a and 1200c are grouped due to their dedication to a storage networking usage and an Ethernet network medium type. As illustrated in FIGS. 11 and 12, interfaces within group 1620, such as 1118a, 1122b, 1218a and 1222b, are described in their corresponding device models as being dedicated to a storage networking usage and an Ethernet network medium type. Similarly, the interfaces of groups 1602 and 1640 also share a common usage and type.

Because MDU devices can include multiple network interfaces with different dedicated usages, one MDU device can be included in a plurality of groups. For example, as depicted in FIG. 16, device model 1100a includes interfaces in all three groups of site model 1600. For each usage group, the MDU devices of a group are assigned IP addresses and/or subnet masks within the ranges defined in a Network model sharing a common usage and/or type with the group. As shown in group 1602, addresses 1412, 1416, and 1418 of network model 1400 are assigned to device interfaces within the group. Moreover, redundancy information, e.g., 1422, provided in the network model can also be considered when assigning IP addresses to device model interfaces to form redundant connections. Assignment of IP addresses defined in a group's corresponding network model can logically associate the interfaces within a site model group and can result in the formation of a model of a dedicated network devoted to a specific usage. For example, interfaces 1108a, 1122b, 1126c, 1218a, and 1222b are all assigned addresses in accordance with IP address range 1312, subnet masks 1316 and gateway IP address 1318 defined in network model 1300 to form a storage network with an Ethernet medium. In addition, the site models can apply a plurality of network models to a plurality of network interfaces that share a common usage and type to form several dedicated networks. As illustrated in FIG. 16, the site model can include groups that form other dedicated networks, such as a control network with an Ethernet medium and a file transfer network with an Ethernet medium. The site model in this way logically associates MDU device models in accordance with a plurality of network models.

It should be noted that a site model can be modified by a user prior to assignment of IP addresses to actual MDU devices. For example, a system in accordance with an aspect of the present principles provides a user with an option remove certain device models labeled of device models within a site model. Subsequently, the system according to an aspect of the present principles can configure MDU devices in accordance with user-modified site models.

Returning now to the exemplary configuration method described in FIG. 4, providing a configuration database comprises: generating device models of network devices 408; generating network models 412; generating site models 416; and storing the site models in a configuration database 420. Upon providing the configuration database 1000, a site model corresponding to the actual MDU devices and network types located at the customer site is selected, step 424. In step 428, each MDU device 128 and their respective physical locations on the network is identified by the control unit 124. In accordance with one implementation, the MDU devices are discovered upon connection to the network by employing a Universal Plug and Play mechanism, as is known in the art, wherein each MDU device identifies itself, describes its capabilities, and provides a type and ordinal description, as described above. Utilizing the Universal Plug and Play mechanism, the central control unit 124 receives identification information via data stream 130, as illustrated in FIG. 1. However, it should be understood that other mechanisms can be employed to identify MDU devices.

Subsequent to identifying MDU devices on the network, in step 432, internet protocol (IP) addresses are automatically assigned to MDU device interfaces in accordance with the site model selected to thereby logically associate MDU device interfaces sharing a common dedicated network usage. Each MDU device is correlated to a device model in the selected site model based on the device's self-description. Additionally, each MDU device interface is assigned the IP address of their corresponding device model interface. As described above, each MDU device can include a plurality of network interfaces that can be redundant and can have different dedicated network usages. As such, a single MDU device can compose a plurality of dedicated networks. Furthermore, dedicated networks of MDU devices, each of which can have a different usage, can be formed by automatically assigning IP addresses to MDU devices in accordance with the site model. As stated above, assignment of IP addresses to device models can result in the formation of models of dedicated networks. The dedicated networks can be manifested in the MDU devices as a result of the IP address assignment. Moreover, devices can be logically associated and linked to an already existing dedicated network by automatically assigning IP addresses to them in accordance with the site model.

By utilizing a site model, a system according to an aspect of the present principles permits automatic configuration of a complex network having a plurality of dedicated networks and a plurality of devices with interfaces that can compose multiple and different dedicated networks. Moreover, the site model can be utilized to automatically configure additional MDU devices connected to the network after the initial configuration. In addition, the site model can be reused to configure networks of other customer sites. For example, in step 448, the configuration method can be performed at a different site by selecting the same site model. Moreover, step 432 can be repeated to logically associate a second plurality of network devices. Step 448 can alternatively correspond to restarting the configuration method to add an additional site at the same customer location. Thus, aspects of the present principles avoid tedious and time consuming manual configuration processes in such networks that otherwise can have required several days to complete.

After assignment of IP address, host files that map IP addresses to MDU devices are distributed to each MDU device on the network, step 436. In step 440, clocks associated with each MDU device can optionally be synchronized to ensure that scheduled, interdependent tasks assigned to multiple MDU devices are performed seamlessly during utilization of a deployed software package, described more fully below. Subsequently, in step 444, network validation tests can optionally be conducted, which include validation of basic connectivity, optimal routing paths and bandwidth requirements. In situations wherein dedicated networks are closed, an aspect of the present principles includes providing a mechanism that “pings” devices over the dedicated networks and provides validation information to the control unit 124 over the control network.

In accordance with one aspect of the present principles, configuration of dedicated networks of MDU devices can be performed within a system software deployment framework. With reference to FIG. 1, according to one implementation of the present principles, a software package 136 enabling automated and streamlined configuration of a network of devices is developed by an engineering division 112, sold by a sales division 108, and commissioned and maintained by a support division 116. Furthermore, software package 136 can be composed of several software subsystems developed by independent groups of the engineering division 112 that, in certain situations, should be installed together. The subsystem components include the software installed on MDU devices, configuration user-interface plug-ins and configuration servers for individual devices. The software package 136 aggregates the software subsystems into a single package to ease distribution. Further, the software package 136 should also include a manifest, detailing the device compatibility of each of the software subsystem components. The manifest can also indicate the version numbers of compatible interfaces and can document dependencies on software components developed by third-parties. The manifest aids in the detection of version mismatches, described more fully below.

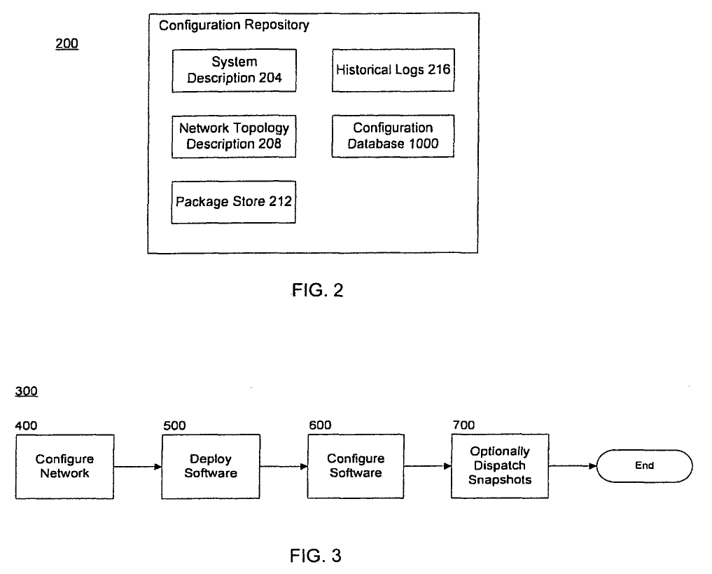

With reference to FIGS. 1 and 2, to facilitate streamlined software package installation and MDU device configuration, another aspect of the present principles includes a central control unit 124, described above, that employs a configuration repository 200. In one implementation of the present principles, the control unit 124 is located at the customer site. In a more specific implementation of the present principles, the configuration repository 200 stores all configuration-related information concerning dedicated networks of MDU devices. The configuration repository 200 can comprise a system description 204, a network topology description 208, a package store 212, historical logs 216 and a configuration database 1000. The configuration database 1000, described more fully above, can be either independent or included within a configuration repository 200. The system description (SD) 204 provides an indication of current hardware and software configuration of the network of MDU devices 128. Additionally, the system description 204 also includes a description of network sites, network groups and the logical relationships of MDU devices composing the network groups. The physical arrangement of MDU devices 128 and their respective connections within the network is provided by the network topology description (NTD) 208. Both the initial SD and initial NTD can be compiled by the sales division 108 and provided to the support division 116 to enable selection of site models and configuration of the customer site network, as described more fully above. In addition, the sales division 108 can utilize the SD 106 to enable efficient market research, as the SD can include information concerning modifications made to MDU devices and systems by customers and service personnel.

The software package 136 is stored in the package store 212, including software components employed by the central control unit 124 to install and configure the subsystems of software package 136. Within its historical logs 216, the configuration repository 200 comprises a record of software installations and MDU device hardware and software configuration modifications and updates. The historical logs 216 can be transmitted to the support division 116 and an on-site maintenance team 132 in the form of configuration snapshots 152, indicating the system description 204 at specific moments in time to enable maintenance and repair of software and hardware components of MDU devices 128. Furthermore, configuration snapshots 152 can also be provided to the engineering 112 division to permit development of enhanced versions of software package 136 and to assist in the maintenance and repair of problems that the support division is unable to resolve.

With reference to FIG. 3, the system 100 described above can be utilized to implement an exemplary method 300 for deploying software and configuring MDU devices in accordance with aspects of the present principles. However, it should be understood that other systems can be employed to execute methods of the present principles and that method 300 is only one example of an implementation of the present principles. As illustrated in FIG. 3, an overview of a method according to an aspect of the present principles includes configuring dedicated networks of MDU devices 400, deploying a software package 500; configuring the software after it is installed on MDU devices 600; and optionally dispatching configuration snapshots 700. The deployment method 300 can begin by implementing configuration steps 400 as described above. Thereafter, the SD 204, the NTD 208, and historical logs 216 of the configuration repository 200 are updated to reflect the network configuration.

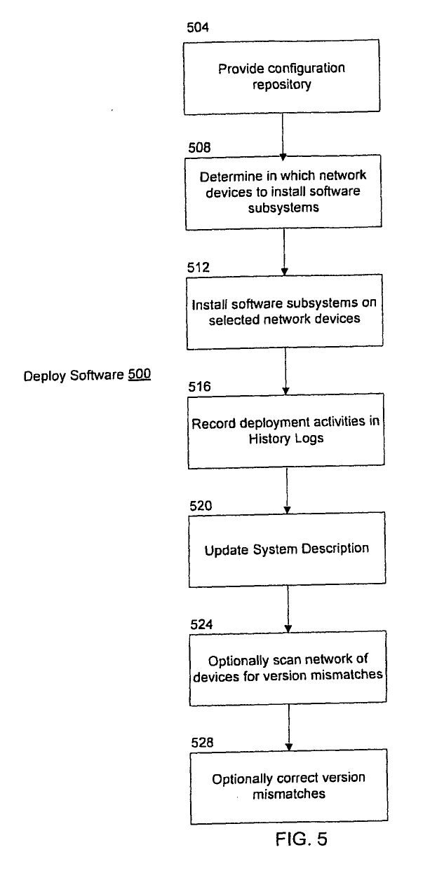

Referring to FIGS. 5 and 1, the next group of steps of method 300 is comprised of software deployment sub-steps 500. In the system 100 described above, the central control unit 124 can effect method steps by issuing commands over stream 144, as shown in FIG. 1. Software deployment 500 can begin by providing a configuration repository, step 504. Thereafter, a system in accordance with an aspect of the present principles determines where to install software-subsystems of a software package, step 508. By employing the Universal Plug and Play mechanism described above in accordance with one aspect of the present principles, the determination step is simplified, as the MDU devices themselves provide identification and capability information. Conversely, the software subsystems indicate the devices with which they are compatible and on which they can be installed. Subsequent to the determination of MDU devices with which software subsystems are compatible, the software subsystems are installed on corresponding MDU devices in step 512. Step 512 can also include installation of software patches on MDU devices having existing software. Additionally, in an implementation of the present principles, the System Description 204 is updated to include the locations of the installed software subsystems.

In accordance with another aspect of the present principles, the deployment of software 500 can optionally include the step of scanning a network of MDU devices to identify software version mismatches, step 524. As referred to herein, a version mismatch is encountered when the actual set of software components installed on an MDU device do not match the expected set of software components. Version mismatch scans can include scanning for package mismatches and individual file mismatches, entailing detection of manual upgrades and any damage to files. Upon discovery of a version mismatch, in step 528, version mismatches can be corrected by updating, removing, and/or installing components, as necessary. Scanning for and correcting version mismatches by utilizing a streamlined process reduces the incidence of software errors. In one implementation of the present principles, MDU devices are dynamically scanned for version mismatches and corrected by employing Windows® Installer Database technology and Windows® Management Interface in conjunction with the System Description.

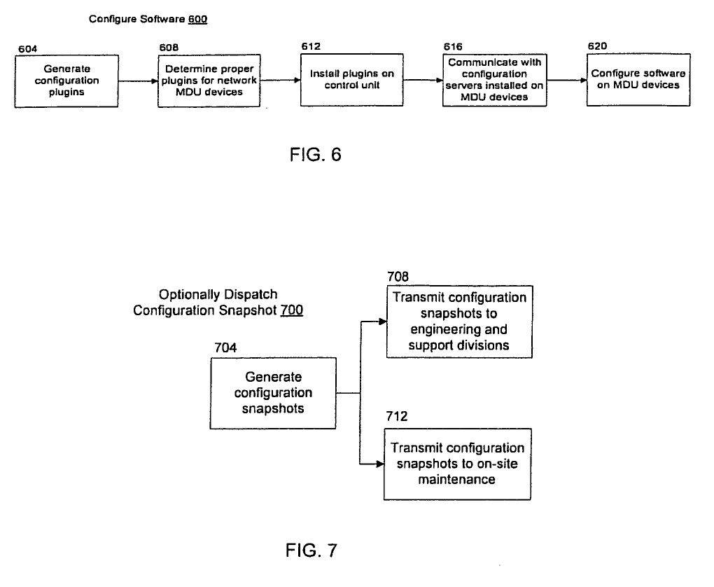

After the software package is deployed, according to another aspect of the present principles, the software is configured by utilizing configuration plug-ins, as depicted in the method of FIG. 6. The system 100, described above, configures software by dispatching commands over stream 140, as illustrated in FIG. 1. In step 604, the configuration plug-ins are generated and adapted to include the type of software role with which it is compatible and information concerning the location of a configuration server on an MDU device. Subsequently, by utilizing the System Description, the system can dynamically determine the appropriate configuration plug-ins for particular MDU devices, step 608, and can then install the configuration plug-ins on the central control unit, step 612. The installation plug-ins communicate, step 616, with configuration servers installed on the MDU devices to configure the software settings on the MDU device, step 620. According to an aspect of the present principles, the installation can be performed in response to a user-command after presenting the correct plug-ins to install for MDU devices through a user-interface.

In another implementation of the present principles, the system can dispatch configuration snapshots 700 to the vendor site, as shown in FIG. 7. A configuration snapshot is a record of the System Description at a particular moment in time. At any given moment, before, during, or after performing the method steps described above, a system in accordance with an aspect of the present principles can generate configuration snapshots by recording the System Description at discrete instances of time. Thereafter, configuration snapshots can be transmitted to either or both the engineering division 112 and the support division 116 of the vendor site, step 708, and to an on-site maintenance team, 712. Transmission can be employed through a radio frequency medium, fiber optic cables, or the like, as is known in the art. The engineering division can utilize configuration snapshots to improve software packages during their development. Additionally, the support division and the onsite maintenance teams can use the information to determine the source of any malfunctions and other errors to facilitate repair of the system, if necessary.

Features and aspects of described implementations can be applied to various applications. Applications include, for example, play to air broadcast applications involving ingest and playout functions; newsroom system applications, including, ingest, editing, archival, media management and playout functions; and post-production systems comprising editing, archival and media management components. The features and aspects herein described can be adapted for other application areas and, accordingly, other applications are possible and envisioned.

The implementations described herein can be implemented in, for example, a method or process, an apparatus, or a software program. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods can be implemented by instructions being performed by a processor, and such instructions can be stored on a processor-readable medium such as, for example, an integrated circuit, a software carrier or other storage device such as, for example, a hard disk, a compact diskette, a random access memory (“RAM”), or a read-only memory (“ROM”). The instructions can form an application program tangibly embodied on a processor-readable medium. As should be clear, a processor can include a processor-readable medium having, for example, instructions for carrying out a process.

As should be evident to one of skill in the art, implementations can also produce a signal formatted to carry information that can be, for example, stored or transmitted. The information can include, for example, instructions for performing a method, or data produced by one of the described implementations. Such a signal can be formatted, for example, as an electromagnetic wave (for example, using a radio frequency portion of spectrum) or as a baseband signal. The formatting can include, for example, encoding a data stream, packetizing the encoded stream, and modulating a carrier with the packetized stream. The information that the signal carries can be, for example, analog or digital information. The signal can be transmitted over a variety of different wired or wireless links, as is known.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method, comprising the steps of:
establishing a unified framework based on a domain-specific system description model representative of physical network system topology, network system device capability and logical network system structure; and
streamlining at least one of a network system configuration process and a software system deployment process in accordance with the unified framework.

2. The method of claim 1 further comprising:
establishing the unified framework in a broadcast equipment environment to augment network system based technologies.

3. The method of claim 1 further comprising:
generating at least one site model including at least two groups of device model interfaces, wherein the device model interfaces are grouped and logically associated in accordance with dedicated usage by assigning addresses to the device model interfaces;
storing the site model in a configuration database; and
logically associating, upon selection of the site model, a first plurality of network devices, each device having a plurality of network interfaces that have dedicated usages, by assigning addresses to the network interfaces in accordance with the site model to automatically form at least two dedicated networks corresponding to dedicated usage of the device model interface groups.

4. The method of claim 3 further comprising:
corresponding at least two of the device model interface groups to different dedicated usages.

5. The method of claim 4 further comprising:
logically associating the first plurality of devices by linking to at least one dedicated network by assigning addresses to the network interfaces in accordance with the site model.

6. The method of claim 5 further comprising:
utilizing a closed dedicated network so that no routes connect it to other networks.

7. The method of claim 5 further comprising:
including redundant connections in the first plurality of network devices.

8. The method of claim 4 further comprising:
including a single network device that has at least two network interfaces that are in at least two different groups.

9. The method of claim 4 further comprising the step of:
logically associating a second plurality of network devices, each device having a plurality of network interfaces that have dedicated usages, by assigning addresses to the network interfaces in accordance with the site model, wherein device models of the site models are reused.

10. The method of claim 4 further comprising the steps of:
providing a configuration repository including a system description, a network topology description, and a system software package having a plurality of different software subsystems;
installing software subsystems on the first plurality of network devices in accordance with the system description and the network topology description; and
configuring the first plurality of network devices by employing configuration plug-ins.

11. A configuration database for use in configuring networked devices having network interfaces that are dedicated to specific network usages, wherein the configuration database includes a computer readable medium and a computer readable program that, when executed on a computer, causes a computer to:
provide at least one site model including at least two groups of device model interfaces, wherein device model interfaces are grouped and logically associated in accordance with dedicated usage by assigning addresses to the device model interfaces, and wherein the address assignment forms models of at least two dedicated networks corresponding to dedicated usage of said at least two groups.

12. The configuration database of claim 9 wherein at least two of said groups correspond to different dedicated usages.

13. The configuration database of claim 10 wherein a single network device has at least two network interfaces that are included in at least two different groups.

14. A system for configuring networked devices having network interfaces that are dedicated to specific network usages comprising:
a configuration database including:
at least one site model including at least two groups of device model interfaces, wherein device model interfaces are grouped and logically associated in accordance with dedicated usage by assigning addresses to the device model interfaces; and
a control unit configured to logically associate, upon selection of the at least one site model, a first plurality of network devices, each device having a plurality of network interfaces that have dedicated usages, by assigning addresses to the network interfaces in accordance with the at least one site model to automatically form at least two dedicated networks corresponding to dedicated usage of said at least two groups.

15. The system of claim 14, wherein at least two of the device model interface groups correspond to different dedicated usages.

16. The system of claim 15, wherein the control unit (124) is further configured to link the first plurality of devices to at least one dedicated network by assigning addresses to the network interfaces in accordance with the site model.

17. The system of claim 16, wherein the first plurality of network devices include redundant connections.

18. The system of claim 16, wherein the dedicated network is closed in that no routes connect it to other networks.

19. The system of claim 17, wherein the control unit logically associates the first plurality of network devices by issuing commands over a control network that is distinct from the dedicated network.

20. The system of claim 15, wherein a single network device has at least two network interfaces that are included in at least two different groups.

21. The system of claim 15, wherein the control unit logically associates a second plurality of network devices, each device having a plurality of network interfaces that have dedicated usages, by assigning addresses to the network interfaces in accordance with the site model, wherein device models of the site models are reused.

22. The system of claim 15, wherein the control unit:
provides a configuration repository including a system description, a network topology description, and a system software package having a plurality of different software subsystems;
installs software subsystems on the first plurality of network devices in accordance with the system description and the network topology description; and
configures the first plurality of network devices by employing configuration plug-ins.
